(19) United States
(12) Patent Application Publication
(10) Pub. No.: US 2009/0039677 A1
(43) Pub. Date: Feb. 12, 2009

(54) Automobile Impact Beam with Integrated Brackets and The Manufacturing Method Thereof

(76) Inventor: Eun-Woo Lee, Daegu (KR)

Correspondence Address: Richard S. Milner;Cooper & Dunham LLP, 1185 Avenue of The Americas, New York, NY, 10036, US

(21) Appl. No.: 12/223,006

(22) PCT Filed: Apr. 4, 2006
(86) PCT No.: PCT/KR2006/001232

§ 371 Date: Jul. 18, 2008

(30) Foreign Application Priority Data
Feb. 2, 2006 (KR) 10-2006-0010170
Feb. 2, 2006 (KR) 10-2006-0010171

(51) Int. Cl. B62D 21/15

(52) U.S. Cl. 296/187.03

(57) ABSTRACT

Disclosed herein are an automobile impact beam integrated with brackets which are fastened to an automobile and a method of manufacturing the automobile impact beam. The automobile impact beam according to the invention includes a body formed from a central area of a hollow steel pipe, and brackets formed from opposite ends of the hollow steel pipe extending from opposite sides of the body, through flattening, so that the brackets are formed as flat surfaces integrated with the body. The invention allows the impact beam to be easily manufactured and mounted to a vehicle, reduces the weight of the vehicle, and provides stability to a passenger.

### TECHNICAL FIELD

The present invention relates, in general, to an automobile impact beam and, more particularly, to an automobile impact beam integrated with brackets which are fastened to an automobile and a method of manufacturing the automobile impact beam.

### BACKGROUND ART

Nowadays, worldwide automobile manufacturers are installing a steel reinforcing member, such as an impact beam, in a door so as to enhance the rigidity of an automobile.

Among the types of steel reinforcing member for automobiles, an impact beam is mounted between an inner plate and an outer plate of an automobile door 5, as shown in FIG. 1. The impact beam mounted in this way minimizes the deformation of and damage to an automobile body, due to impacts caused in broadside collisions between automobiles, thus minimizing injury to a driver or to passengers.

As described above, the impact beam for automobiles is usually made of a high-tension steel plate which is formed to have a wave shape. However, recently, in order to achieve the lightness of an automobile and increase the fuel efficiency of the automobile, the impact beam is manufactured using a hollow steel pipe to have high impact resistance and superior ability to absorb impacts.

FIG. 2 is a perspective view showing the conventional impact beam, which is constructed as described above and is disclosed in Korean Patent Publication No. 1994-3248.

As shown in FIG. 2, the conventional impact beam 1 manufactured using the hollow steel pipe includes a body 2 comprising a hollow steel pipe. Brackets 3 and 4 are provided on opposite ends of the body 2, and are attached to the inner plate or an inner surface of the outer plate of the door 5. Generally, after the brackets 3 and 4 are manufactured through an additional manufacturing operation, the brackets 3 and 4 are welded to the body 2.

That is, the conventional impact beam 1 for automobiles is problematic in that at least two brackets 3 and 4 must be separately manufactured to attach the impact beam 1 to the inner side of the automobile door 5, so that the operation of welding the brackets must be added to the automobile manufacturing process, thus undesirably increasing the number of operations. Further, the deformation caused by the welding operation affects the quality and rigidity of a product. Furthermore, the brackets 3 and 4 are separately installed, thus increasing the weight of an automobile.

### DISCLOSURE OF THE INVENTION

Technical Tasks to be Solved by the Invention

Accordingly, the present invention has been made keeping in mind the above problems occurring in the prior art, and an object of the present invention is to provide an automobile impact beam integrated with brackets and a method of manufacturing the impact beam, in which an area of a hollow steel pipe forming a bracket is expanded through pressing or hydro-forming, and the bracket is formed integrally with a body of the impact beam through pressing, thus increasing the strength of the impact beam, decreasing the weight of an automobile, and being easy to manufacture.

Technical Solution

In order to accomplish the object, the present invention provides an automobile impact beam integrated with brackets, including a body formed from a central area of a hollow steel pipe, and brackets formed from opposite ends of the hollow steel pipe extending from opposite sides of the body, through flattening, so that the brackets are formed as flat surfaces integrated with the body.

Each of the brackets is formed by forming a sheared area having a predetermined length in each of the opposite ends of the hollow steel pipe, and inserting an expander into an opening of each of the opposite ends of the hollow steel pipe to expand the opening.

Further, each of the brackets is formed by pressing each of the opposite ends of the hollow steel pipe extending from the opposite sides of the body.

The body is heat treated so as to increase strength.

The hollow steel pipe has one selected from a circular cross-section and an elliptical cross-section.

A support rib is attached to each of the brackets so as to increase a force coupling the impact beam to an automobile.

In order to accomplish the object, the present invention provides a method of manufacturing an automobile impact beam integrated with brackets, including a heat treatment step of heat treating a body area of a hollow steel pipe, opposite ends of the hollow steel pipe forming the brackets and an area of the hollow steel pipe between the brackets forming a body; and a bracket forming step of forming the integral brackets by flattening the opposite ends of the hollow steel pipe, after the heat treatment step has been completed.

The bracket forming step includes a shearing step of forming sheared areas each having a predetermined length in the opposite ends of the hollow steel pipe, after the heat treatment step has been completed; and an expanding step of inserting an expander into openings having the sheared areas to expand the openings, thus forming the brackets.

The bracket forming step includes a flattening step of flattening the opposite ends of the hollow steel pipe through pressing, thus forming the brackets, after the heat treatment step has been completed.

The bracket forming step further includes a support-rib forming step of forming a support rib on a surface of each of the brackets.

In order to accomplish the object, the present invention provides an automobile impact beam integrated with brackets, including a body manufactured by heat treating a hollow steel pipe, and forming a central area of the automobile impact beam; and brackets integrally formed on opposite ends of the body by expanding ends which are provided on opposite sides of a heat-treated area of the hollow steel pipe and are not heat treated, and thereafter pressing the ends.

Each of the brackets is formed by expanding an area of the hollow steel pipe which is not heat treated, through hydro forming, and thereafter pressing the area.

The hollow steel pipe has one selected from a circular cross-section and an elliptical cross-section.

A support rib is attached to each of the brackets so as to increase a force coupling the impact beam to an automobile.

In order to accomplish the object, the present invention provides a method of manufacturing an automobile impact beam integrated with a bracket, including a heat treatment step of heat treating an area of a hollow steel pipe, which forms a body of the impact beam; an expanding step of expanding an area of the hollow steel pipe other than the area which forms the body through the heat treatment; and a bracket forming step of forming a bracket integrated with the heat-treated area by pressing the area expanded through the expanding step.

The bracket forming step further includes a cutting step of cutting an expanded bracket area, when the heat treatment is executed in at least two areas of the hollow steel pipe and a bracket area between the heat-treated areas is expanded.

The bracket forming step further includes a support-rib forming step of forming a support rib on a surface of each of the brackets which are formed through pressing.

### Advantageous Effects

As described above, an impact beam for vehicles (automobiles) according to the present invention is manufactured so that an area of a member forming a bracket is cut and thereafter pressed, or is expanded through hydro-forming, is cut and thereafter is pressed, and thus the bracket is integrated with the impact beam in a single structure. As a result, the operation of mounting a separately manufactured bracket to a body of the impact beam is not required, thus minimizing the number of parts and the working period which are required for the manufacture and assembly of the impact beam.

Further, in an impact beam for automobiles according to the present invention, a hollow steel pipe is processed through heat treatment, so that impact resistance and the ability to absorb impacts are improved, thus enhancing stability and realizing lightness, therefore maximizing fuel efficiency.

### BRIEF DESCRIPTION OF DRAWINGS

FIG. 1 is a view showing the state where a conventional impact beam for automobiles is mounted to an automobile door;

FIG. 2 is a perspective view showing the conventional impact beam for automobiles;

FIG. 3 is a perspective view showing an automobile impact beam integrated with brackets, according to an embodiment of the present invention;

FIG. 4 is a flowchart illustrating a method of manufacturing the automobile impact beam integrated with the brackets, according to an embodiment of the present invention;

FIG. 5 is a perspective view showing the impact beam, after completion of heat treatment of FIG. 4;

FIG. 6 is a perspective view showing the impact beam, after completion of a shearing step of FIG. 4;

FIG. 7 is a view showing an expanding step of FIG. 4;

FIG. 8 is a perspective view showing the impact beam, when support ribs are provided on a bracket which has been fabricated;

FIG. 9 is a perspective view showing another automobile impact beam integrated with a bracket, according to the present invention;

FIG. 10 is a perspective view showing an automobile impact beam integrated with brackets through expanding and pressing, according to another embodiment of the present invention;

FIG. 11 is a flowchart illustrating a method of manufacturing the automobile impact beam integrated with brackets through expanding and pressing, according to another embodiment of the present invention;

FIG. 12 is a perspective view showing a hollow steel pipe used to make the impact beam, after completion of heat treatment of FIG. 11;

FIG. 13 is a perspective view showing the state where parts of the hollow steel pipe forming the brackets are expanded, after completion of heat treatment of FIG. 11;

FIG. 14 is a perspective view showing part of an impact beam having a bracket which is formed through pressing, after completion of the expanding step of FIG. 13; and

FIG. 15 is a perspective view showing the impact beam, when support ribs are provided on the bracket after fabrication thereof.

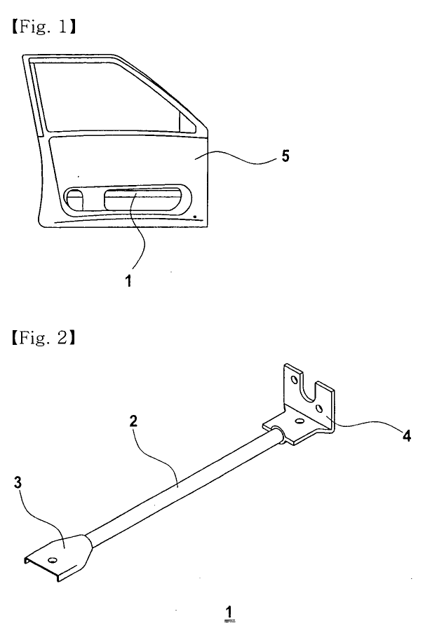

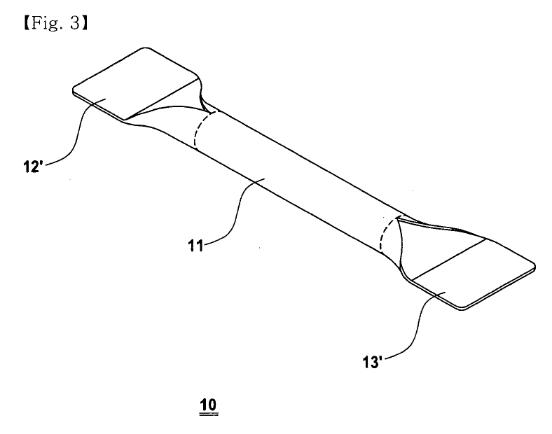

### BEST MODE FOR CARRYING OUR THE INVENTION

Hereinafter, the present invention will be described in detail with reference to the accompanying drawings.

FIG. 3 is a perspective view showing an automobile impact beam integrated with brackets, according to an embodiment of the present invention.

As shown in FIG. 3, the automobile impact beam 10 according to an embodiment of the present invention comprises a hollow steel pipe, and brackets 12′ and 13′ are integrated with opposite ends of the hollow steel pipe. An area provided between the brackets 12′ and 13′ forms a body 11.

In order to reduce the weight of the impact beam 10, the impact beam 10 is manufactured from a hollow steel pipe. The impact beam 10 is not limited to a specific cross-section, but it is preferable that the impact beam 10 has a circular or elliptical cross-section. More preferably, the impact beam has an elliptical cross-section so as to have high impact resistance and superior ability to absorb impacts. Further, the body 11 is heat treated so as to maximize rigidity and impact absorbing ability.

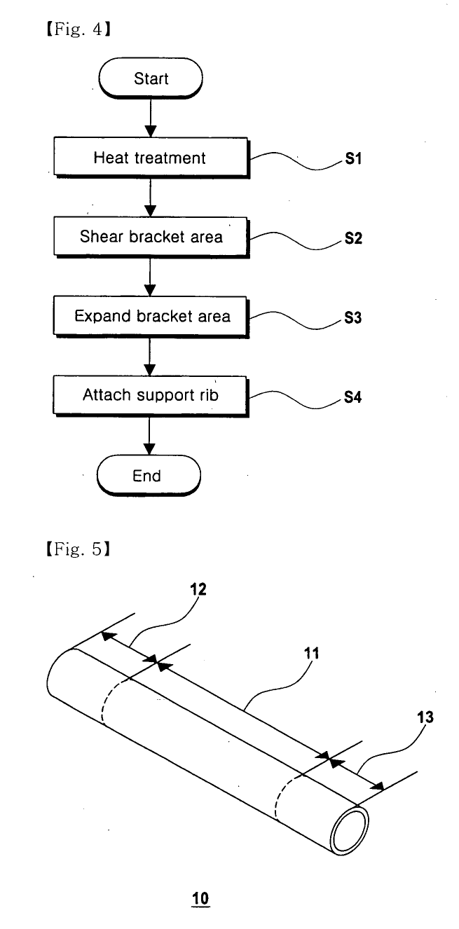

The hollow steel pipe goes through flattening operation, thus forming the brackets 12′ and 13′ such that they are integrated with the body 11. The flattening operation is performed as follows. That is, sheared areas 14 (see, FIGS. 4 to 7) each having a predetermined length are formed in the longitudinal direction of the body 11, and are expanded by an expander 15 (see, FIG. 7), and thereafter are forged, thus forming the brackets 12′ and 13′. As an alternative to this method, the brackets may be formed through pressing without the necessity of forming the sheared areas 14, as shown in FIG. 9.

In order to facilitate the above-mentioned flattening operation, it is preferable that the brackets 12′ and 13′ not be heat treated. However, if heat treatment is required, it is preferable that the heat treatment be performed after the brackets have been formed.

Further, in order to allow the impact beam 10 to be easily attached to a vehicle (automobile) and firmly maintain the attached state, support ribs 16 may be attached to the brackets 12′ and 13′. The support ribs 16 have a shape corresponding to that of the surface of the vehicle (automobile) to which the impact beam is mounted.

FIG. 4 is a flowchart illustrating a method of manufacturing the automobile impact beam integrated with brackets using a sheared-area forming step, according to an embodiment of the present invention, and FIGS. 5 to 8 are perspective views showing impact beams which are processed according to respective steps of FIG. 4.

Hereinafter, the method of manufacturing the automobile impact beam integrated with the brackets by forming the sheared areas, according to the present invention, will be described with reference to FIG. 3 and FIGS. 5 to 8.

The method of manufacturing the automobile impact beam integrated with the brackets by forming the sheared areas 14 is as follows. As shown in FIG. 5, at the heat treatment step S1, the central area of the hollow steel pipe forming the body 11 of the impact beam 10 is heat treated so as to maximize rigidity and impact absorbing ability. Preferably, opposite ends 12 and 13 of the hollow steel pipe are not heat treated, to facilitate the subsequent flattening operation.

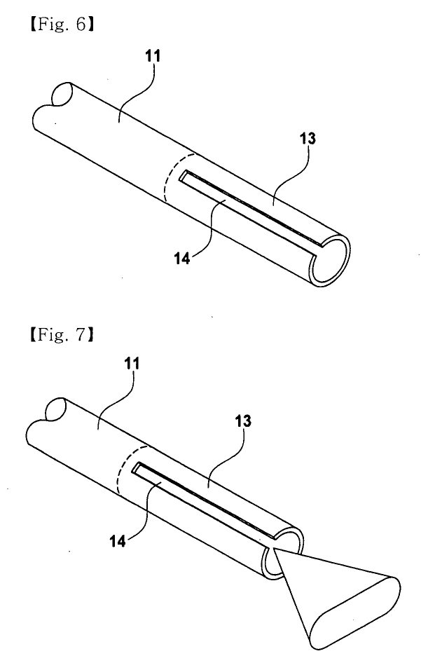

Next, as shown in FIG. 6, at the bracket-area shearing step S2, the sheared areas 14 are formed in the opposite ends 12 and 13 of the hollow steel pipe forming the brackets in such a way as to have a predetermined length in the longitudinal direction of the hollow steel pipe. That is, a tool, which has a concave part corresponding to the shape of each sheared area 14, is inserted into the hollow steel pipe. In such a state, a convex part corresponding to the concave part is pressed at the exterior, so that part of the hollow steel pipe is removed, thus forming the sheared area 14.

After the sheared areas 14 are formed at step S2, as shown in FIG. 7, the wedged expander 15 is inserted into the opening of each of the ends 12 and 13 of the hollow steel pipe in which the sheared areas 14 are formed. Thereafter, the expander 15 is pressed to expand the sheared areas 14, thus forming the brackets 12′ and 13′. Next, a forging operation for smoothing a surface may be additionally performed, at bracket-area expanding step S3.

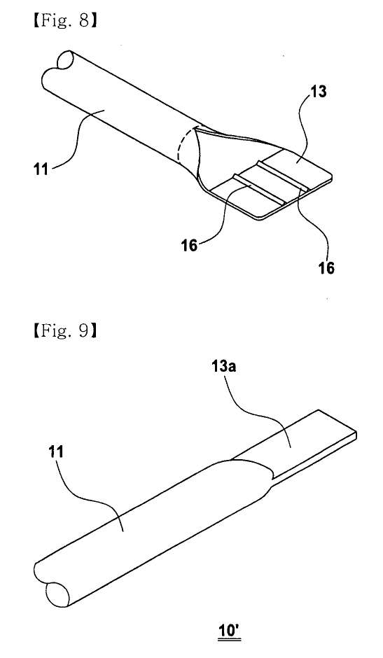

After the brackets 12′ and 13′ have been formed at step S3, as shown in FIG. 8, the support ribs 16 are attached to surfaces of the brackets 12′ and 13′, at the support-rib forming step S4. The support ribs 16 function to firmly attach the impact beam 10 to the automobile. Thus, the shape of the support ribs 16 corresponds to that of the surface to which the brackets 12′ and 13′ of the automobile impact beam 10 are attached, without being limited to the shape of FIG. 8.

FIG. 9 is a perspective view showing an impact beam 10′, according to a modification of the present invention.

Referring to FIG. 9, a bracket 13a is formed through pressing without forming the sheared area on the outer circumferential surface of the hollow steel pipe. In this case, the bracket is formed by overlapping the outer circumferential surface of the hollow steel pipe, so that the strength of the bracket is doubled.

In the case of the impact beam 10′ of FIG. 9, the body 11 is heat treated so as to improve strength, impact resistance and impact absorbing ability, as shown in FIG. 4. Further, after the pressing operation is performed, a forging operation for providing a flatter surface, a heat treatment operation, and a support-rib attaching operation may be performed.

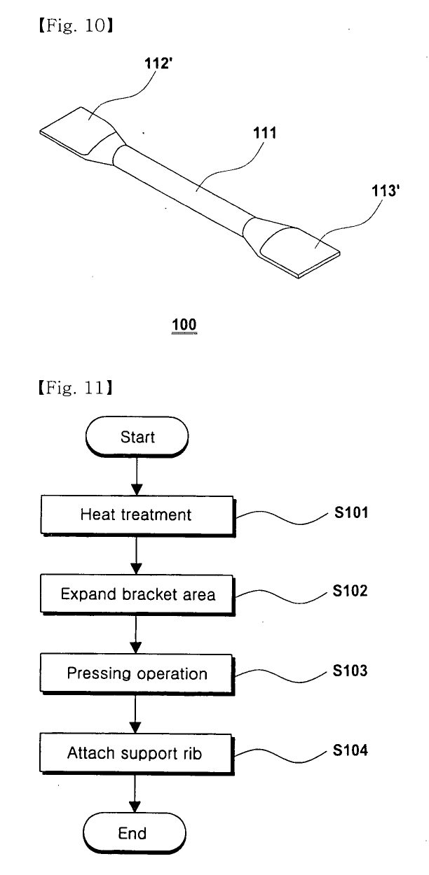

FIG. 10 is a perspective view showing an automobile impact beam integrated with brackets through expanding and pressing, according to another embodiment of the present invention.

As shown in FIG. 10, the automobile impact beam 100 according to another embodiment of the present invention comprises a hollow steel pipe. The area of the hollow steel pipe which is heat treated forms a body 111. Opposite ends of the body 111 are expanded and pressed, thus forming brackets 112′ and 113′. Thereby, the brackets are integrated with the body in a single structure.

In order to realize lightness of the impact beam 100, the impact beam 100 is manufactured using the hollow steel pipe. The impact beam is not limited to a specific cross-section, but it is preferable that the impact beam has a circular or elliptical cross-section. More preferably, the impact beam has an elliptical cross-section so as to have high impact resistance and superior impact absorbing ability. Further, the area of the hollow steel pipe corresponding to the body 111 is heat treated so as to maximize rigidity and impact absorbing ability.

Next, areas which are not heat treated are expanded and pressed, so that the brackets 112′ and 113′ are formed integrally with the body 111.

In a detailed description, the opposite ends 112 and 113 of the hollow steel pipe forming the brackets 112′ and 113′, and a bracket area 114, which is formed between heat-treated areas of the hollow steel pipe and is not heat treated, are expanded through hydro forming or a similar operation. After the expansion is completed, the expanded bracket area 114 is cut along a cutting line 115. Thereafter, the expanded areas formed by the opposite ends 112 and 113 of the heat-treated area are pressed, thus forming the brackets 112′ and 113′.

The brackets 112′ and 113′ may be heat treated so as to maximize rigidity and impact absorbing ability after the pressing operation is completed. Further, support ribs 116, corresponding to the surface of a vehicle (automobile) to which the impact beam is to be attached, may be attached to the brackets 112′ and 113′ so as to allow the impact beam 100 to be easily attached to the vehicle (automobile) and firmly maintain the attached state.

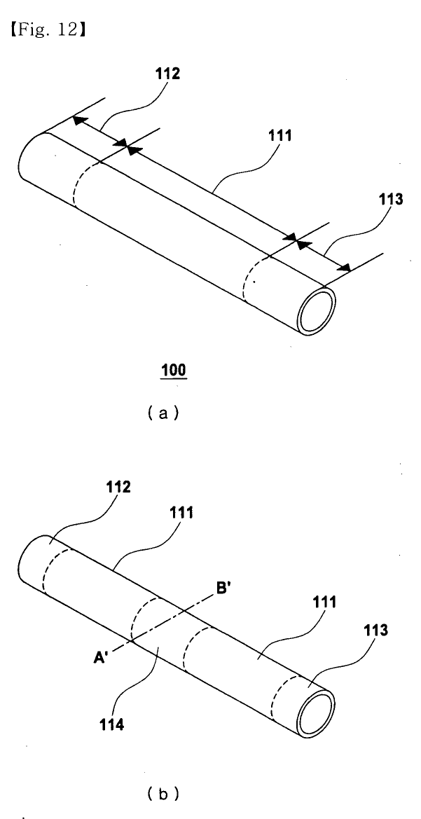

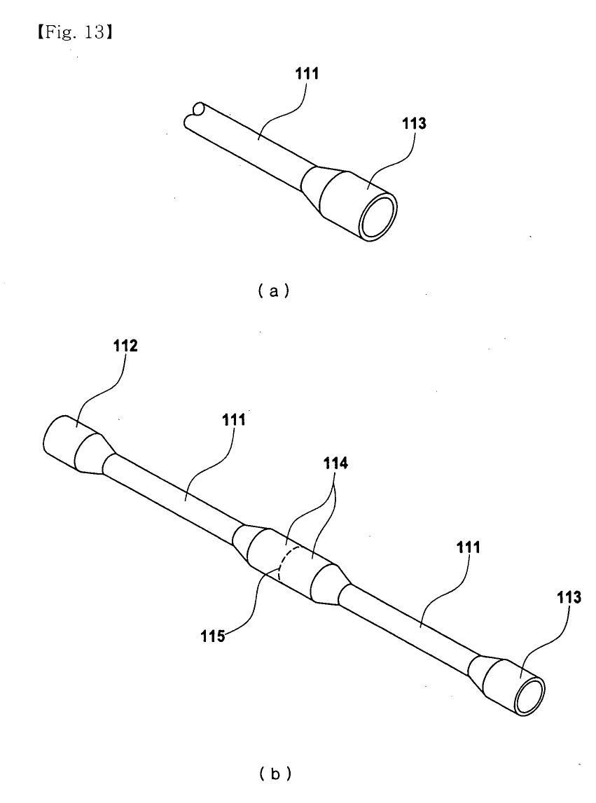

FIG. 11 is a flowchart illustrating a method of manufacturing the automobile impact beam integrated with brackets through expanding and pressing, according to another embodiment of the present invention, and FIGS. 12 to 15 are perspective views showing each state of a hollow steel pipe for forming the impact beam according to respective steps of FIG. 11.

Hereinafter, the method of manufacturing the automobile impact beam integrated with the brackets through expanding and pressing, according to another embodiment of the present invention shown in FIG. 11, is described with reference to FIGS. 10 and FIGS. 12 to 15.

The method of manufacturing the automobile impact beam integrated with the brackets through expanding and pressing is performed as follows. That is, as shown in FIG. 11, at the heat treatment step S101, the area of the hollow steel pipe forming the body 111 of the impact beam 100 is heat treated to maximize rigidity and impact absorbing ability. Preferably, as described above, the opposite ends 112 and 113 of the hollow steel pipe and the bracket area 114, which is provided between the heat-treated areas and is not heat treated, are not heat treated, to facilitate the subsequent expanding operation.

FIG. 12 shows the hollow steel pipe which is heat treated at step S101. FIG. 12a shows the heat treated state, when the central area of the hollow steel pipe forms the body 111. FIG. 12b shows the heat treated state, when the central area of the hollow steel pipe forms the bracket area 114 and opposite sides of the bracket area 114 form bodies 111.

After the heat treatment step S101 has been terminated, the opposite ends 112 and 113 and the bracket area 114 of the hollow steel pipe, which are not heat treated, are expanded through hydro forming or a similar expanding operation, at the expanding step S102.

FIG. 13 shows the opposite ends 112 and 113 and the bracket area 114 of the hollow steel pipe, which are expanded at step S102 and are not heat treated. In this case, FIG. 13a shows the state where the end 113 of the hollow steel pipe is expanded. FIG. 13b shows the state where the opposite ends 112 and 113 of the hollow steel pipe and the bracket area 114, provided in the center of the hollow steel pipe, are expanded.

After the expanding operation has been performed at step S102, the expanded ends 112 and 113 are pressed, thus forming the brackets 112′ and 113′ (bracket forming operation). In the case of having the expanded bracket area, a cutting operation is performed along the cutting line 115 of the center of the bracket area 114. The expanded bracket area 114 is cut to form the expanded ends 112 and 113 of the body 111 which are heat treated. Preferably, the bracket area 114 is twice as long as the bracket 112′ or 113′, thus allowing the brackets provided on opposite ends of the heat-treated body 111 to have the same length through cutting. In this case, the cutting operation may be performed after the expanded bracket area 114 is pressed, at step S103.

FIG. 14 is a view showing the bracket 113′ integrated with the body 111 through pressing at step S103.

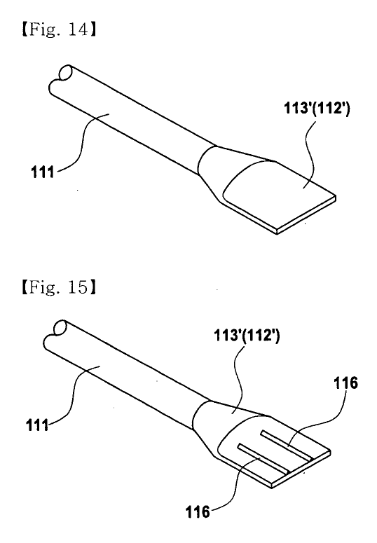

After the brackets 112′ and 113′ are formed on the opposite ends of the body 111 at step S103, as shown in FIG. 15, the support ribs 116 are attached to the surface of each of the brackets 112′ and 113′, at the support-rib forming step S104. The support ribs 116 function to firmly attach the impact beam 100 to an automobile. To this end, the support ribs 16 have a shape corresponding to that of the surface to which each of the brackets 112′ and 113′ of the automobile impact beam 100 is to be mounted. Thus, the support ribs 116 may have various shapes, and are not limited to the shape of FIG. 15.

### INDUSTRIAL APPLICABILITY

As described above, the present invention allows an impact beam, which is mounted to a door to increase impact resistance and impact absorbing ability against external impacts acting on a vehicle, to be easily manufactured, and is usefully applicable to the automobile industry.

1. An automobile impact beam integrated with brackets, comprising:
a body formed from a central area of a hollow steel pipe; and
brackets formed from opposite ends of the hollow steel pipe extending from opposite sides of the body, through flattening, so that the brackets are formed as flat surfaces integrated with the body.

2. The automobile impact beam according to claim 1, wherein each of the brackets is formed by forming a sheared area having a predetermined length in each of the opposite ends of the hollow steel pipe, and inserting an expander into an opening of each of the opposite ends of the hollow steel pipe to expand the opening.

3. The automobile impact beam according to claim 1, wherein each of the brackets is formed by pressing each of the opposite ends of the hollow steel pipe extending from the opposite sides of the body.

4. The automobile impact beam according to claim 1, wherein the body is heat treated so as to increase strength.

5. The automobile impact beam according to claim 4, wherein the hollow steel pipe has one selected from a circular cross-section and an elliptical cross-section.

6. The automobile impact beam according to claim 5, wherein a support rib is attached to each of the brackets so as to increase a force coupling the impact beam to an automobile.

7. A method of manufacturing an automobile impact beam integrated with brackets, comprising:
a heat treatment step of heat treating a body area of a hollow steel pipe, opposite ends of the hollow steel pipe forming the brackets and an area of the hollow steel pipe between the brackets forming a body; and
a bracket forming step of forming the integral brackets by flattening the opposite ends of the hollow steel pipe, after the heat treatment step has been completed.

8. The method according to claim 7, wherein the bracket forming step comprises:
a shearing step of forming sheared areas each having a predetermined length in the opposite ends of the hollow steel pipe, after the heat treatment step has been completed; and
an expanding step of inserting an expander into openings having the sheared areas to expand the openings, thus forming the brackets.

9. The method according to claim 7, wherein the bracket forming step comprises:
a flattening step of flattening the opposite ends of the hollow steel pipe through pressing, thus forming the brackets, after the heat treatment step has been completed.

10. The method according to claim 8, wherein the bracket forming step further comprises:
a support-rib forming step of forming a support rib on a surface of each of the brackets.

11. An automobile impact beam integrated with brackets, comprising:
a body manufactured by heat treating a hollow steel pipe, and forming a central area of the automobile impact beam; and
brackets integrally formed on opposite ends of the body by expanding ends which are provided on opposite sides of a heat-treated area of the hollow steel pipe and are not heat treated, and thereafter pressing the ends.

12. The automobile impact beam according to claim 11, wherein each of the brackets is formed by expanding an area of the hollow steel pipe which is not heat treated, through hydro forming, and thereafter pressing the area.

13. The automobile impact beam according to claim 12, wherein the hollow steel pipe has one selected from a circular cross-section and an elliptical cross-section.

14. The automobile impact beam according to claim 13, wherein a support rib is attached to each of the brackets so as to increase a force coupling the impact beam to an automobile.

15. A method of manufacturing an automobile impact beam integrated with a bracket, comprising:
a heat treatment step of heat treating an area of a hollow steel pipe, which forms a body of the impact beam;
an expanding step of expanding an area of the hollow steel pipe other than the area which forms the body through the heat treatment; and
a bracket forming step of forming a bracket integrated with the heat-treated area by pressing the area expanded through the expanding step.

16. The method according to claim 15, wherein the bracket forming step further comprises:
a cutting step of cutting an expanded bracket area, when the heat treatment is executed in at least two areas of the hollow steel pipe and a bracket area between the heat-treated areas is expanded.

17. The method according to claim 15, wherein the bracket forming step further comprises:
a support-rib forming step of forming a support rib on a surface of each of the brackets which are formed through pressing.
